(19) United States
(12) Patent Application Publication
(10) Pub. No.: US 2002/0161671 A1
(43) Pub. Date: Oct. 31, 2002

(54) Information presentation method and device

(75) Inventors: Kazuki Matsui, Kawasaki (JP); Soichi Nishiyama, Kawasaki (JP); Masatomo Yasaki, Kawasaki (JP); Toshiaki Gomi, Kawasaki (JP); Hitoshi Okumura, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/955,049

(22) Filed: Sep. 19, 2001

(30) Foreign Application Priority Data
Apr. 27, 2001 (JP) 2001-132377

(51) Int. Cl. G06F 17/60

(52) U.S. Cl. 705/27

(57) ABSTRACT

The present invention is to efficiently exploit user needs. When a user registers a product in a favorites list, proxy server 2 saves the search parameters for that product. Proxy server 2 presents the search parameters saved in text or icon format to a user terminal 1, and accepts changes to the search parameters. Proxy server 2 receives a product purchase selection from user terminal 1, and saves the purchase history of the user. By presenting users' purchase histories to a vendor terminal 3 and the like, a product provider will know the degree to which what information presented to what user is effective. A product provider can effectively present information and promote an increase in sales.

### BACKGROUND OF THE INVENTION

1. Technical Field

The present invention relates to technology that advertises products and services that are purchased on a network.

2. Description of Related Art

There are currently a large number of websites on the Internet for users to reserve and purchase airline seats and hotel rooms for travel.

Generally, when reserving a hotel room and the like, a user can select a hotel that he or she wishes to reserve a room in on a website. In addition, if a user registers a hotel in which he or she wishes to reserve a room in a favorites list or web browser bookmarks presented to each user on that website, the user can check that hotel again at a later date, and make a reservation when it is convenient for him or her.

Further, with a shopping site that has a shopping cart function, products that one desires to purchase can be registered in the shopping cart, and can be purchased as a group at a later date. Moreover, with a website that provides a so-called “gift registry” service, products that a particular user wants are registered on a wish list that is provided to other users on that site. The wish list can be displayed to friends of the user and others, and friends can see it and make the user a present of products that fulfill the user's desires.

Moreover, a service is also provided in which a favorites list or a wish list is prepared in addition to a shopping cart and a user can register products that he or she is thinking of purchasing at a later date therein.

However, even if products are registered in a favorites list and the like, there are often cases where these goods are not purchased afterward. For example, there are many users that register a hotel in a favorites list for a time, but do not make a reservation afterward. This can happen because, although once the user was thinking of making a reservation, the user has changed his/her mind after wavering about making a reservation due to a lack of information or the like. A similar case can also be presumed when the purchase of a product occurs. Thus, after a user registers a hotel or products in a favorites list, it is thought that if there is a mechanism that prompts the user to execute a reservation, there will be an increase in sales.

Prompting purchases by employing a recommendation engine to transmit recommendation information and the like can be cited as a general method of increasing sales used by product providers that conduct on-line sales. In this method, a user's tastes are analyzed by the recommendation engine, products that appear to be suitable for and information that appears to be desired by each user are automatically found, and recommendation information is generated. However, because the generation of the recommendation information is strictly based only upon a statistical process, it does not necessarily correspond to the detailed requirements of each individual user. Because of the circumstances like this, product providers that conduct on-line sales need to have an opportunity to speak to each user by any method, and want to know what information users want and what their requirements are. If product providers know the information and requirements like this and deal therewith, the degree of user satisfaction can be increased, a relationship of trust can be consequently established between users and product providers, and an increase in sales can be promoted.

Product providers want to take up the needs of a user.

However, they want to do so at a low cost without expending time and energy and want to respond to the user's needs. For example, in the event that the product provider is a hotel, it is a burden to the hotel to answer an unlimited number of questions from a user and providing an unlimited amount of information to him or her. Moreover, if in the end that user does not use the hotel, the user support is not effective. Further, there are users that are seriously considering making a reservation, and users that are just “window shopping”. Moreover, there are users that are making a reservation for the first time, and repeat users that have stayed at that hotel a number of times. Thus, to treat all users equally is not appropriate in view of cost effectiveness and customer satisfaction.

On the other hand, though a user searches for a product online, sometimes she or he immediately can not decide to purchase the product, and wants to wait for a period of time until they actually reserve or purchase a product. For example, even if the user can use a search engine to narrow down the number of hotels to a certain level, there are times when the user wants additional information in order to select one hotel from amongst this group. However, the hotel cannot know if the user cannot decide, or wants more information. Because of that, the user has to gather additional information for each hotel by contacting them by telephone or sending them e-mails. This means that the user has to communicate all of his or her needs or requirements to all of the hotels, and is too much to handle.

The present invention extracts the needs of a user over a network, without any burden to the user, and provides technology that can increase sales of products and service provided over a network by using the extracted needs.

### SUMMARY OF THE INVENTION

In the present invention, user needs and requests are efficiently extracted over a network, and based on the information extracted, high quality user support service can be provided by determining who the good customers are, selecting candidates for this designation, and determining what information is to be provided to them.

A first aspect of the present invention provides an information presentation method that is employed in an information presentation system, in which a user retrieves a product or service on a network that matches designated search parameters designated by the user, and presents it to the user. The method comprises the steps of A-D:

A: storing the search parameters and the product or service;

B: reporting the product or service and the search parameters that were stored to a provider of the product or the service;

C: accepting settings of information relating to the product or service from the product/service provider; and

D: presenting the information to the user that relates to the product or service that was set.

This method stores the search parameters that a user employs to find and retrieve a product or a service via a network, and provides the search parameters to a product/service provider. Advertisement of the product or service, or new product development, can effectively take place because the product/service provider and their competitors can know what the needs of the user are from the search parameters. only the search parameters for the product or service that the user is interested in may be stored, rather than all search parameters for the products or services retrieved. For example, storing the search parameters for products that were registered in a favorites list or wish list or the like of a shopping site or a gift registry can be cited.

A second aspect of the present invention provides an information presentation device in which a user terminal on a network that retrieves products or services that match search parameters designated by the user. The device comprises:

A: accepting means for accepting a selection of a product or service that is included in the products or services that were retrieved; and

B: parameter storage means for storing the search parameters for the selected product or service as a candidate for purchase, together with user identification information that identifies the user terminal.

This device stores the search parameters that a user employs to find and retrieve a product or service via a network. The stored search parameters are search parameters for products or services that were registered in a favorites list or wish list of a shopping site or a gift registry site. These are products or services that users have a high degree of interest in, and in turn, it is thought that there is a high degree of probability that they will be purchased at a later date.

If the device provides the stored search parameters to users, product (service) providers, and other third parties, these groups can use the search parameters. For example, one advantage is that if users can see the product search parameters registered in their own favorites list, they can later confirm the characteristics of the products retrieved. Product providers and their competitors can effectively conduct product advertising and new product development because they can know the needs of users from the search parameters. In addition, research companies and consulting companies can also provide advice relating to market research and management based upon the user needs shown by the search parameters. Thus, those that run this device can anticipate obtaining a usage fee from product providers, research companies, and the like for the search parameters acquired.

A third aspect of the present invention provides the information presentation device according to the second aspect, further comprising:

C: user reference request accepting means for accepting user reference requests from first computer terminals on the network; and

D: parameter providing means for extracting from the parameter storage means a first user identification information identifying the first user terminals that have selected a first product as a candidate for purchase that is provided by an administrator of a provider terminal included in the first computer terminals, and search parameters that each of the first user terminals has set to the first product, and providing them to the provider terminal.

As discussed previously, if, for example, search parameters are provided to a product (service) provider or its competitor, they can conduct effective advertising and new product development based upon the needs of the user indicated by the search parameters.

A fourth aspect of the present invention provides the information presentation device according to the third aspect. The device further comprises:

information setting means for receiving from the provider terminal the designation of user identification information included in the first user identification information provided to the provider terminal, and product information settings for the designated user identification information;

product information storage means for storing the designated user identification information, the first product, and the product information that was set; and

information presentation means for receiving a purchase candidate reference request from a designated user terminal identified by the designated user identification information, extracting from the parameter storage means candidates for purchase that correspond to the designated user identification information, extracting the product information set for the first product that is included in the candidates for purchase from the product information storage means, and providing the extracted candidates for purchase and the product information to the designated user terminal.

A product provider can provide a product or a service that is adapted to the needs of each individual user. For users, the advantage is that they can learn about products and services that meet their needs without spending time.

A fifth aspect of the present invention provides the information presentation device according to the second aspect, further comprising first parameter providing means for receiving a purchase candidate reference request from the user terminal, extracting candidates for purchase that correspond to the user identification information for the user terminal that made the request, and providing the extracted candidates for purchase and the search parameters to the user terminal that made the request.

As discussed above, users can confirm the characteristics of the products or services registered in their favorites list at a later date.

A sixth aspect of the present invention provides the information presentation device according to the fifth aspect, further comprising:

change means for receiving changes to the search parameters provided to the user terminal that made the request;

candidate update means for updating the candidates for purchase that correspond to the user identification information of the user terminal that made the request, based upon the changed search parameters; and

second parameter providing means for providing updated candidates for purchase and new search parameters to the user terminal that made the request.

A user can change the search parameters in accordance with changes in their own needs, and update the favorites list. For example, a user can add “hot spring, outdoor hot spring included” to their first search parameter “Room reservation from Jun. 2-3, 2000”. Further, accommodations that match the search parameters in the favorites list can be updated in accordance with changes to the search parameters.

A seventh aspect of the present invention provides the information presentation device according to the fifth aspect. The device further comprises:

purchase means for receiving designations of products or services included in the candidates for purchase from the user terminal and purchase designations;

purchase history storage means for storing the designated products or designated services received by the purchase means, and a user identification information identifying the user terminal that made the designations;

user reference request receiving means for receiving a user reference request from the first computer terminals on the network; and

purchase information presentation means for extracting from the parameter storage means a first user identification information identifying a first user terminals that have selected products or services as candidates for purchase that are provided by the administrator of a provider terminal included in the first computer terminals, and search parameters that each of the first user terminals has set to the products or services, generating a purchase information that indicates whether or not each of the first user terminals has completed a purchase of the products or the services based on the purchase history storage means, and providing the extracted first user identification information, the extracted search parameters, and the generated purchase information to the provider terminal.

For example, a product provider can refer to, in a user list registered in users favorites lists, whether users have already determined to purchase their products. By distinguishing between users that are affected by product information, and those that are not, a product provider can efficiently use the presentation of product information.

An eighth aspect of the information presentation device according to the seventh aspect, wherein the purchase history storage means further stores the first identification information that identifies the first computer terminals and the designated products correlatively; and

the information presentation device further comprises history dissemination means for providing the purchase history of the products that the administrator of the provider terminal provides.

In the event that the service provider is, for example, a hotel, that hotel can refer to a user list that registers that hotel in a favorites list to determine what user has stayed how many times at that hotel. Depending on whether or not the user is a frequent customer, the hotel can make changes to the product information to be presented, and more efficiently present product information.

A ninth aspect of the present invention provides the information presentation device according to the third aspect, further comprises an agent terminal storage means for correlatively stores third identification information for representing second computer terminals that is included in the first computer terminals, and for identifying third computer terminals that are included in the first computer terminals, and second identification information that identifies second computer terminals that are represented by each of the third computer terminals identified by the third identification information.

There are situations in which a product (service) provider does not have a means of connecting to a network, or a product provider does not have sufficient human resources for presenting product information. An agent may present the product information on behalf of this type of product (service) provider. For example, a computer belonging to a travel agent that presents information on an old hot spring resort on its behalf, or a computer belonging to a real estate agent that presents information on a house on behalf of the individual that wants to sell the house, may be connected to the present device.

A product (service) provider can promote its products or services without increasing its workload. An agent can present a wide range of products and services to users, and can anticipate an increase in the degree of trust from users. Further, even for a provider of the present device, this is preferable because the present device is related to an increase in the quality of the service that it provides.

A tenth aspect of the present invention provides the information presentation device according to the third aspect. The device further comprises an agent terminal storage means for correlatively storing third identification information for representing second computer terminals that is included in the first computer terminals, and for identifying a third computer terminals that are included in the first computer terminals, and second identification information that identifies second computer terminals that are represented by each of the third computer terminals identified by the third identification information identifies;

agent parameter storage means for storing agent parameters for agent terminals that are included in the third computer terminals to represent provider terminals that are included in the second computer terminals, together with the third identification information for the agent terminals and the second identification information for the provider terminals; and

an agent means for receiving a connection request from the second computer terminals or the third computer terminals, setting up the connection or rejecting the connection according to the agent parameters.

For example, hotel A requests travel agent T to represent it between 23:00 to 06:00 for the presentation of product information. In this situation, the present device switches the product information provider for hotel A between travel agent T and hotel A day and night. If done in this manner, a product (service) provider and an agent can coexist with each other, and the present device can improve the quality of service provided.

An eleventh aspect of the present invention provides an information presentation method used in a computer, that retrieves products or services that match search parameters selected by user terminals on a network and presents them to the user terminals. The method comprises the steps of:

receiving a selection of any product or service that is included in the products or services retrieved; and

storing the search parameters that retrieved the products or services as candidates for purchase together with user identifying information that identifies the user terminals.

A twelfth aspect of the present invention provides a computer program product for an information presentation and for being employed in a computer that retrieves products or services that match search parameters selected by user terminals on a network and presents them to the user terminals. The program comprises:

receiving means for receiving a selection of any product or service that is included in the products or services retrieved; and

parameter storing means for storing the search parameters that retrieved the products or services as candidates for purchase together with user identifying information that identifies the user terminals.

A thirteenth aspect of the present invention provides a computer readable recording medium, on which an information presentation program is recorded and employed in a computer that retrieves products or services that match search parameters selected by user terminals on a network and presents them to the user terminals. The information presentation program recorded on a computer readable recording medium comprises the steps of:

receiving a selection of any product or service that is included in the products or services retrieved; and

storing the search parameters that retrieved the products or services as candidates for purchase together with user identifying information that identifies the user terminals.

The program that is recorded on a recording medium operates a computer as a device that is a second embodiment of the invention. Here, a computer readable floppy disk, hard disk, semiconductor memory, CD-ROM, DVD, magneto-optical disk (MO), and other similar items, can be cited as recording media.

A fourteenth aspect of the present invention provides a computer terminal that receives search parameter selections for searching products or services on a network, and reports the products or services that match the search parameters to users, the computer terminal on a network comprising:

candidate selection means for selecting any product or service that are included in the product group or the service group as candidates for purchase;

transmission means for transmitting the candidates for purchase and the search parameters therefor to an information presentation device on the network that stores purchase candidates and search parameters for each of the purchase candidates;

request means for transmitting a reference request for referencing the purchase candidates to the information presentation device;

acquiring means for acquiring the purchase candidates and the search parameters for each of the purchase candidate from the information presentation device; and

output means for outputting purchase candidates acquired and search parameters acquired for each of the acquired purchase candidates.

This computer terminal acts as a user terminal in the aforementioned second embodiment of the invention.

A fifteenth aspect of the present invention provides a computer terminal on a network that is operated by a product provider or a service provider. The computer terminal comprises:

user reference request means for retrieving products or services that match search parameters designated by user terminals on the network and presenting them to the user terminals, receiving any product or service selection that is included in the products or services retrieved, and transmitting a user reference request via the network to an information presentation device that stores the search parameters of the products or services retrieved as purchase candidates, and user identification information that identifies the user terminals;

parameter acquiring means for acquiring a first user identifications corresponding to a first user terminals that select products or services provided by the product provider or the service provider as purchase candidates, and search parameters that are set to each of the products or services of the first user terminals; and

an output means for outputting the first user identifications acquired and the search parameters acquired.

Here, the product (service) provider also includes an agency that acts on behalf thereof in the sales of products and services.

From the following detailed description in conjunction with the accompanying drawings the foregoing and other objects, features, aspects and advantages of the present invention will become readily apparent to those skilled in the art.

### BRIEF DESCRIPTION OF THE DRAWINGS

FIG. 1 is an overall configuration diagram of a sales increasing system according to a first embodiment;

FIG. 2 is a block diagram of the functions of each terminal in the sales increasing system of FIG. 1;

FIG. 3 is a conceptual explanatory diagram of a product information DB in the sales increasing system of FIG. 1;

FIG. 4 is a conceptual explanatory diagram of a favorites list DB in the sales increasing system of FIG. 1;

FIG. 5 is a conceptual explanatory diagram of a user list DB in the sales increasing system of FIG. 1;

FIG. 6 is a conceptual explanatory diagram of a purchase history DB in the sales increasing system of FIG. 1;

FIG. 7 is a conceptual explanatory diagram of an authentication DB in the sales increasing system of FIG. 1;

FIG. 8 is a conceptual explanatory diagram of an agent DB in the sales increasing system of FIG. 1;

FIG. 9 is an explanatory diagram showing the overall process flow in the sales increasing system of FIG. 1;

FIG. 10 is an explanatory diagram showing the flow of a search parameter saving process in the sales increasing system of FIG. 1;

FIG. 11 is an explanatory diagram showing the flow of a search parameter display process and a search parameter change process in the sales increasing system of FIG. 1;

FIG. 12 is an explanatory diagram showing the flow of a user list reference process in the sales increasing system of Fig.

FIG. 13 is an explanatory diagram showing the flow of a product information setting process in the sales increasing system of FIG. 1;

FIG. 14 is an explanatory diagram showing the flow of a session switching process of FIG. 12;

FIG. 15 is an explanatory diagram showing the flow of a purchase process in the sales increasing system of FIG. 1;

FIG. 16 is an example of a search parameter designation screen displayed on a user terminal;

FIG. 17 is an example of a favorites list registration screen displayed on a user terminal;

FIG. 18 is an example of a favorites list display screen that includes search parameters displayed on a user terminal;

FIG. 19 is a second example of a favorites list display screen that includes search parameters displayed on a user terminal;

FIG. 20 is an example of a user list display screen displayed on a vendor terminal or an agent terminal; and

FIG. 21 is a conceptual explanatory diagram of a product information DB in another embodiment.

### DETAILED DESCRIPTION OF THE PREFERRED EMBODIMENTS

Overview of the Invention

Normally, users locate products and services to register in the favorites lists and wish lists of shopping sites and gift registries (hereinafter, collectively referred to as favorites lists) by designating the search parameters on a search system and conducting a search. In the system of the present invention, when a user registers products and services in a favorites list, the search parameters of those products and services are acquired and saved. The search parameters will differ according to the search system, however in view of the mechanical process, it is preferred that an ID be pre-assigned to each search parameter, and that these IDs be paired with their parameter so that they can be conveniently processed and registered in the present system. Of course, the search parameters may be free key words. In addition, in the present system, the search parameters are communicated to the user in a visually identifiable form such as a text display or an icon display. Moreover, the present system accepts changes to the search parameters in accordance with changes in the needs of the user.

Further, in the present system, the provider of the products or services can reference users that have registered their company's products and/or services in a favorites list. From the viewpoint of the product provider or the service provider side, they can know about users that have registered their company's products and/or services in a favorites list, and the total number thereof. Note that the method of making the favorites list available to a product provider or a service provider is not particularly limited. For example, the method disclosed in Japanese patent application 2000-185157 can be employed.

The present system also has an agent means by agents. Because of this, a product provider can provide a high quality user support service, even if the product provider does not have a means of connecting to a network or user support personnel. Further, a wide variety of product providers can participate in the present system as agents, and an improvement in the quality of user support service can be planned.

In addition to this, in the present system, a product provider can see the actual purchases of a user. If the product provider provides information, it will know whether it is effective, and can determine whom the good customers are. Thus, the product provider can effectively provide information and promote sales.

First Embodiment

Next, the method of presenting information in the sales increasing system of the present invention will be described by using a hotel reservation system on a network as an example.

Configuration

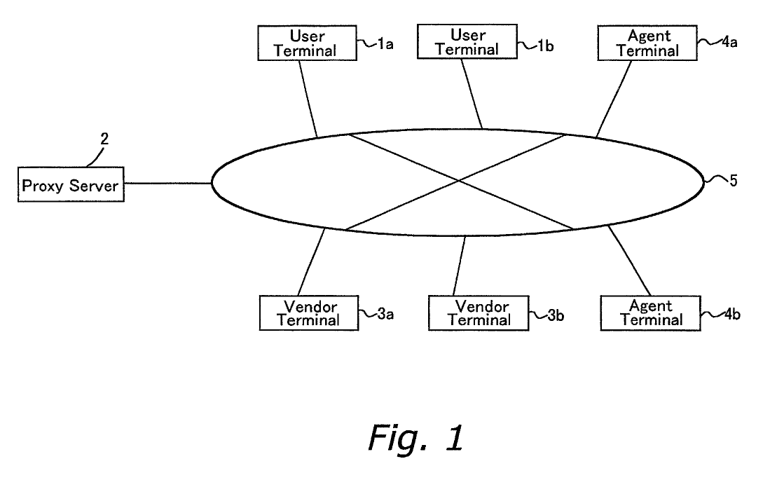

FIG. 1 shows the overall configuration of a first embodiment of the sales increasing system. This sales increasing system is composed of a plurality of user terminals 1a, b, a proxy server 2, a plurality of vendor terminals 3a, b, and a plurality of agent terminals 4a, b, all connected to a network 5. The user terminals 1 are computers that users operate to search for information on hotels as the products. Proxy server 2 is a computer that provides the product information search results to the user terminal 1. The vendor terminals 3 are computers that hotels as the providers of the products (hereinafter referred to as “vendors”) operate. The agent terminals 4 are host terminals belonging to agents that provide hotel information to users on behalf of a hotel. A travel agent can be an agent.

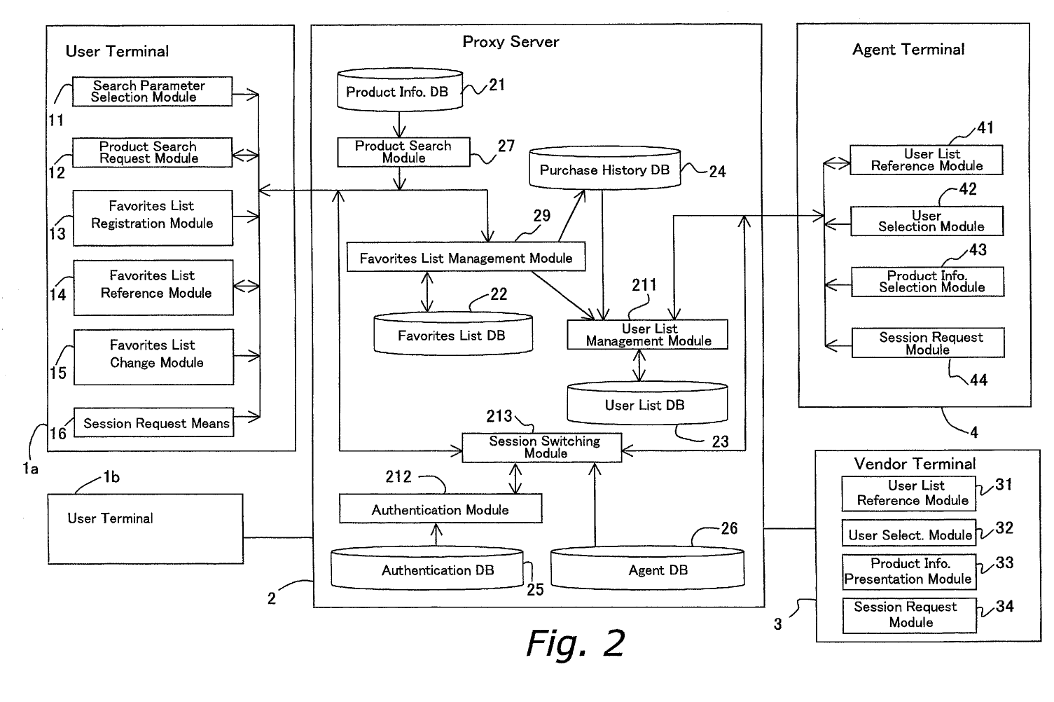

FIG. 2 is a block diagram that shows the functions of each terminal. The following is a sequential description of each terminal.

(1) Proxy Server

Proxy server 2 has a plurality of databases (DB) and a plurality of modules. First, the databases will be described, and then the function of the modules will be described.

(1-1) Proxy Server Databases

The proxy server 2 has a product information DB 21, a favorites list DB 22, a user list DB 23, a purchase history DB 24, an authentication DB 25, and an agent DB 26.

(1-1-1) Product Information DB

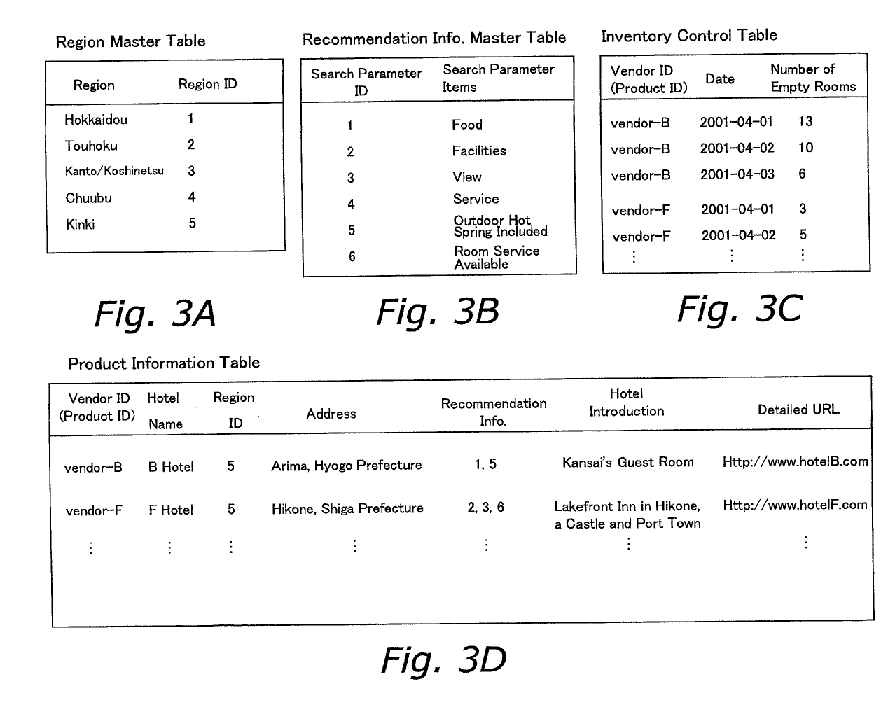

FIG. 3 describes the conceptual explanatory diagram of product information DB 21. This DB stores the products that the vendor provides, and detailed information on these products. In the present embodiment, this DB stores (a) a region master table, (b) a recommendation information master table, (c) an inventory control table, and (d) a product information table.

The “region name” and the “region ID” that identifies the region are matched and stored in the region master table.

The “search parameter item” for searching the hotel as a product, and the “search parameter ID” that identifies each search parameter item are stored in the recommendation information master table.

Product inventory, here the empty rooms, is stored for each vendor in the inventory control table. Specifically, a “vendor ID” that identifies the vendor, a “date”, and the “number of empty rooms” for each day are stored therein. In this embodiment, the “vendor ID” is the same as the product ID that identifies the product.

Specific details for each vendor's products are stored in the product information table. Specifically, the “vendor ID”, “hotel name”, “region ID”, the “address” of the hotel, “recommendation information”, “hotel introduction”, and “detailed URL” are stored in the product information table. In this example, “vendor ID” is the same as the product ID. In “region ID”, any region ID that is stored in the region master table is noted therein. Further, one or a plurality of search parameter IDs that are registered in the recommendation information master table are read into “recommendation information”. A catchphrase that a hotel creates for general use is read into “recommendation information”. The URL of a hotel's home page is read into “detailed URL”.

(1-1-2) Favorites List DB

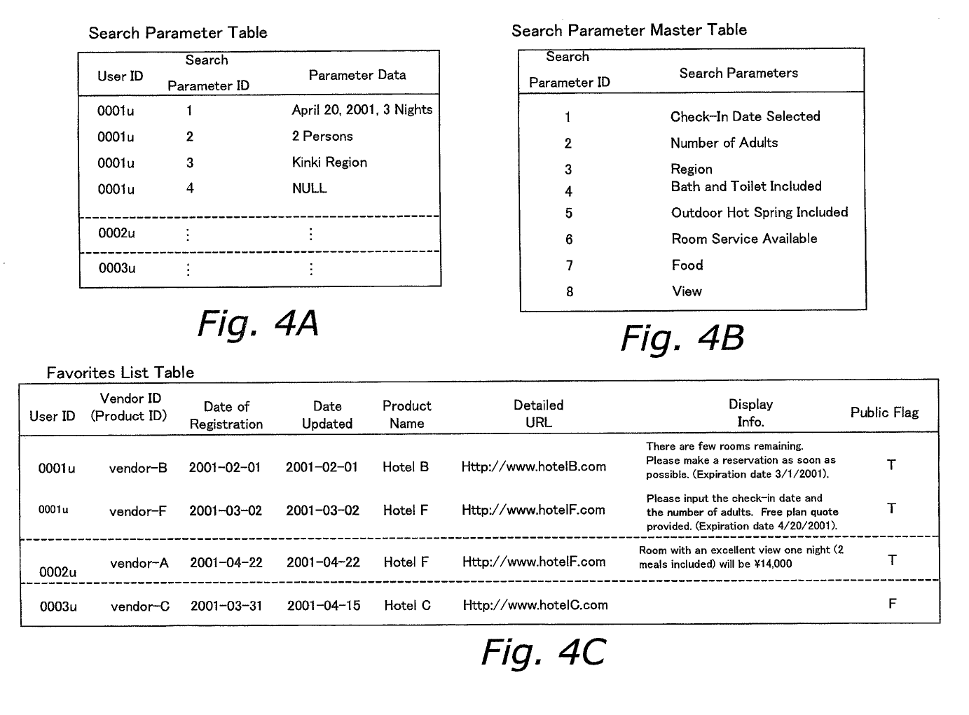

FIG. 4 describes the conceptual explanatory diagram of favorites list DB 22. This DB stores the products that users are interested in, and their search parameters. In this embodiment, this DB has (a) a search parameter table, (b) a search parameter master table, and (c) a favorites list table stored therein.

User search parameters for each user are stored in the search parameter table. A “user ID” that identifies a user terminal, a “search parameter ID”, and “parameter data” are stored herein. The “search parameter ID” is described in one or a plurality of search IDs that identify the search parameter items that are registered in the search parameter master table. Contents set by the user in response to the search parameter items that are specified by the search parameter IDs are read into “parameter data”. For example, for search parameter ID “1” that corresponds to the date of check-in and the length of stay, “2001/4/20, 3 nights” will be read in as the parameter data.

The “search parameter items” and the “search parameter IDs” that specify the search parameter items are matched and stored in the search parameter master table.

The favorites list table stores favorite products that users have an interest in, or in other words, candidates for purchase. In this embodiment, “user ID”, “vendor ID”, “registration date”, “date updated”, “product name”, “Picture URL”, “display information”, and “public flag” are stored therein. “User ID” is identical with the user ID employed in the aforementioned search parameter table. “Vendor ID” is identical to the vendor ID employed by the aforementioned product information DB 21, and is employed here as a product ID that identifies the products. “Registration date” and “date updated” display the month, day and year that the favorite products were registered in this table, and the month, day and year of the last renewal of the record. The name of the products that are specified by the vendor IDs which also serve as product IDs, here, the name of the hotels, are written in “product name”. The URL of the home pages of the hotels is written in “Image URL”. Advertising information that the hotel provides to each user is written in “presentation information”. In “public flag”, if T (true) is presented, then the record is publicly presented by the vendor, and if F (false) is presented, then the record is not public.

(1-1-3) User List DB

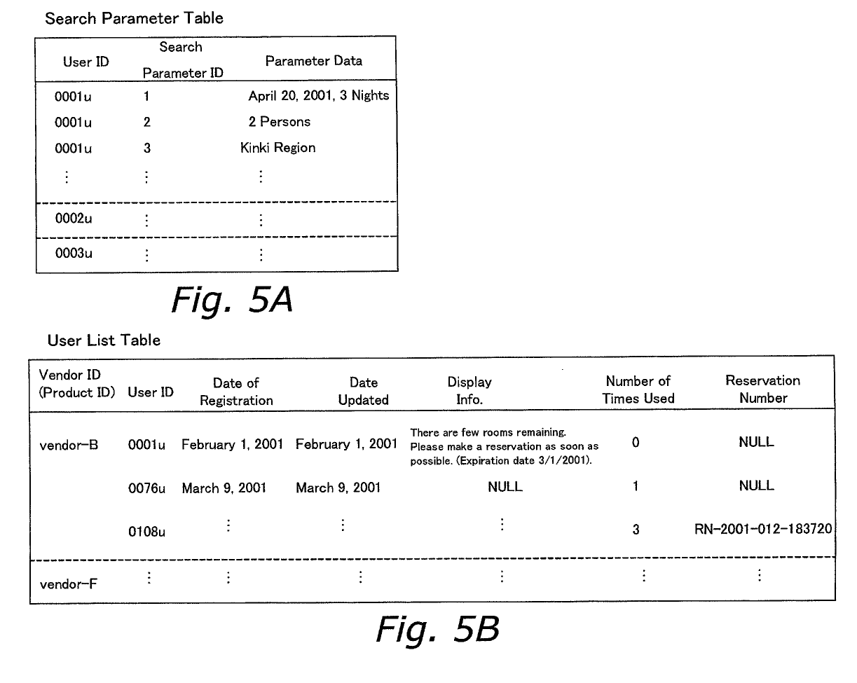

FIG. 5 describes the conceptual explanatory diagram of user list DB 23. An (a) search parameter table, and (b) user list table, are stored in this DB.

The search parameter table stores information that is similar to that in the search parameter table of the aforementioned favorites list DB 22.

The user list table stores a user list for each vendor. This user list is a collection of users that have registered products that the vendors provide in the favorites list. Specifically, a “vendor ID” that is the same as the product ID, a “user ID”, “registration date”, “date updated”, “presentation information”, “number of times used”, and “reservation number” are stored therein. The “vendor ID” also serves as the product ID as mentioned above, and both identifies the hotel as a product and identifies the hotel itself as a vendor. “User ID” is the user IDs of the user terminals that have registered a hotel specified by a vendor ID of each record in their favorites list. For example, users “0001U”, “0076U”, and “0108U” have registered “vendor-B” in their favorites list. The “registration date” and the “date updated” display the month, day and year that each record was registered and the month, day and year that each record was updated. The “presentation information” is information that is similar to the “presentation information” of the aforementioned favorites list table. The “number of times used” displays the number of times that the user has used the hotel in the past. The “registration number” is a payment ID that is written in when a user requests a hotel reservation. For example, user “0108U” has reserved vendor “vendor-B”.

(1-1-4) Purchase History DB

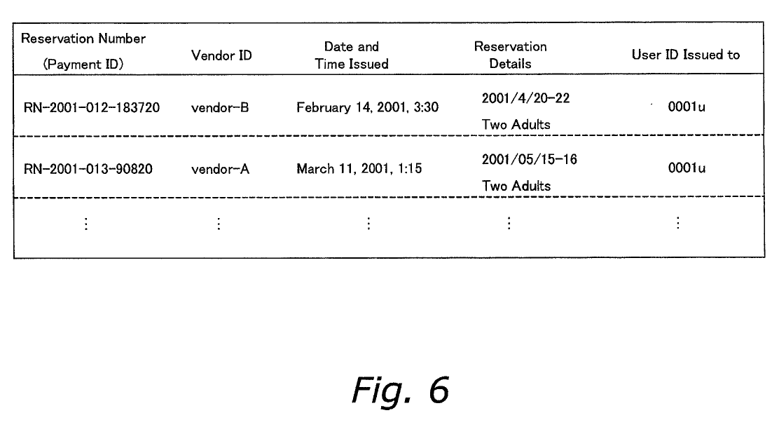

FIG. 6 describes the conceptual explanatory diagram of purchase history DB 24. Users' purchase histories are stored in this DB. Specifically, a “reservation number” that also serves as the payment ID, a “vendor ID” that also serves as the product ID, an “issue date”, “reservation contents” and “user ID issued to” are stored in this DB. The “reservation number” is any reservation number that is in the user list table of the aforementioned user list DB 23. The “vendor ID” is used here as a product ID that identifies a product. The “issue date” presents the time and date that a user has requested a hotel reservation. Contents of the parameter data that the user designated are written in “reservation details”. “User ID issued to” is the user ID of the user terminal through which the reservation was made.

(1-1-5) Authentication DB

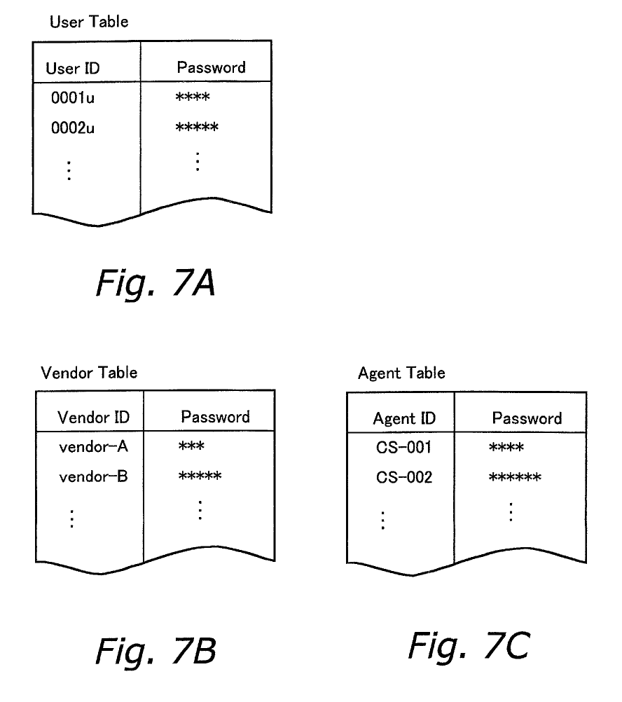

FIG. 7 describes the conceptual explanatory diagram of authentication DB 25. Authentication information is stored in this DB in order to access favorites list DB 22, user list DB 23, and purchase history DB 24. Specifically, authentication DB 25 has (a) a user table, (b) a vendor table, and (c) an agent table.

The “user ID” and each user's “password” are stored in the user table. The “vendor ID and each vendor's “password” are stored in the vendor table. An “agent ID” that identifies the agent terminal and each agent's “password” is stored in the agent table.

(1-1-6) Agent DB

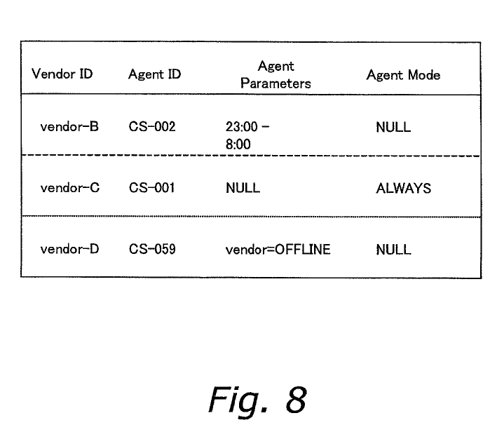

FIG. 8 describes the explanatory diagram of an agent DB 26. This DB stores the correspondence between the vendor terminals and agent terminals, as well as agent parameters. Specifically, a “vendor ID”, an “agent ID”, “agent parameters”, and the “agent mode” are stored in this DB. The parameters for the agent terminals to act on behalf of the vendor terminals to do such things as refer to the user list and display information are stored in “agent parameters”. For example, agent terminal “CS-002” acts as an agent for vendor terminal “vendor-B” from 23:00 in the evening to 08:00 in the morning. In addition, agent terminal “CS-059” acts as an agent for vendor terminal “vendor-D” when it is off line.

(1-2) Proxy Server Functions

The proxy server 2 includes the databases discussed earlier, and has a product search module 27, a favorites list management module 29, a user list management module 211, an authentication module 212, and a session switching module 213.

A product search module 27 extracts from product information DB 21 the products that match the search parameters designated from the user terminal 1, and displays the extracted products in the user terminal 1. A favorites list management module 29 writs in to and reads out from favorites list DB 22. In addition, the favorites list management module 29 writes product purchases into purchase history DB 24. A user list management module 211 generates and updates the user list in user list DB 23. An authentication module 212 authenticates user terminals 1 connected to proxy server 2, vendor terminals 3, and agent terminals 4. A session switching module 213 establishes or rejects a session between the vendor terminals 3 and the agent terminals 4, and the proxy server 2 according to an agent DB26.

(2) User Terminals

The user terminals 1 have a search parameter selection module 11, a product search request module 12, a favorites list registration module 13, a favorites list reference module 14, a favorites list change module 15, and a session request module 16. It is not necessary for these functions to always be in the user terminals 1. For example, they can be effectuated by Java Script, Java applets, CGI, and the like.

A search parameter selection module 11 receives product search parameter designations. A product search request module 12 transmits the search parameters designated to the proxy server 2, and outputs the products that match the search parameters acquired from the proxy server 2.

A favorites list registration module 13 receives the designation of favorite products from amongst the products that match the search parameters, and communicates the favorite products to the proxy server 2. A favorites list reference module 14 transmits the favorites list reference request to the proxy server 2, and outputs the favorite products and the search parameters acquired from the proxy server 2. A favorites list change module 15 receives changes to the favorite products and changes to the search parameters, and transmits them to the proxy server 2. A session request module 16 requests that a session be established with the proxy server 2.

(3) Vendor Terminals 3 and the Agent Terminals

The vendor terminals 3 and agent terminals 4 have similar functions. The functions of vendor terminals 3 will be described below. Each vendor terminal 3 has a user list reference module 31, a user selection module 32, a product information presentation module 33, and a session request module 34. It is not necessary for these functions to always be in the vendor terminals 3. For example, they can be effectuated by Java Script, Java applets, CGI, and the like.

The user list reference module 31 transmits a user list reference request to the proxy server 2, and acquires and outputs the user list. The user selection module 32 accepts any selection of a user from amongst the user list output. The product information presentation module 33 receives presentation information settings for the aforementioned selected user, and transmits this to the proxy server 2. The session request module 34 transmits a request to establish a session with the proxy server 2 to the proxy server 2.

Process Flow

Next, the process flow of the present sales increasing system will be explained with reference to the figures.

(1) Overall Flow

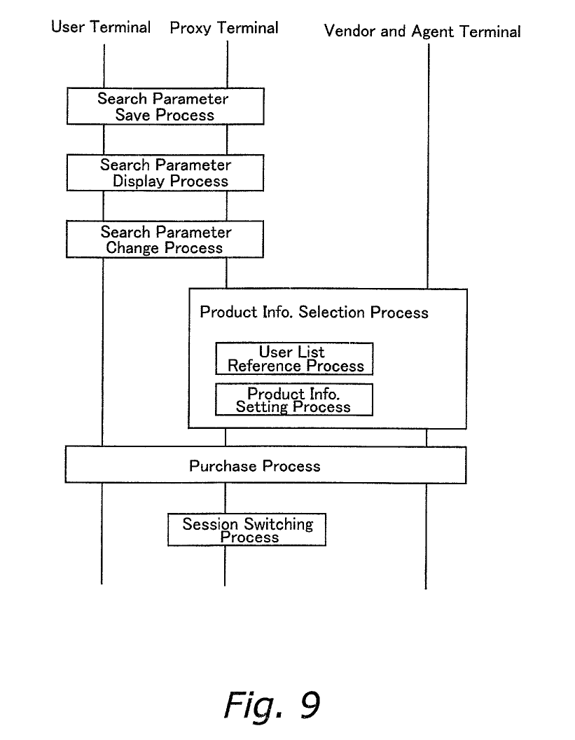

FIG. 9 describes the overall process flow that occurs in the present system.

(1-1) Extracting, Displaying, and Changing the Search Parameters

In the present system, a search parameter save process, a search parameter display process, and a search parameter change process occurs between the user terminals 1 and the proxy server 2. Users can save the search parameters of the products registered in the favorites list in the proxy server 2 by means of these processes. In addition, the favorites list can be displayed together with the search parameters, and changes thereto can be received.

(1-2) Display Information Settings

In the present system, a product information presentation process occurs between the proxy server 2 and the vendor terminals 3 or the agent terminals 4. The product information display process includes a user list reference process and a product information setting process. A list of users that register interest in a vendor s products can be displayed in the vendor terminals 3 and the agent terminals 4 by means of the former process. In addition, presented information set by a vendor can be registered in the proxy server 2 by means of the latter process. The proxy server 2 conducts a session switching process in order to establish a session between it and any vendor terminal 3 or agent terminal 4 of that vendor.

(1-3) Information Presentation Results

In addition, a purchase process occurs in the present system. This process refers to the presented information, and updates the purchase history of the user that made a reservation at a hotel, the favorites list, and the user list belonging to the hotel in which a reservation was made.

(2) Search Parameter Save Process

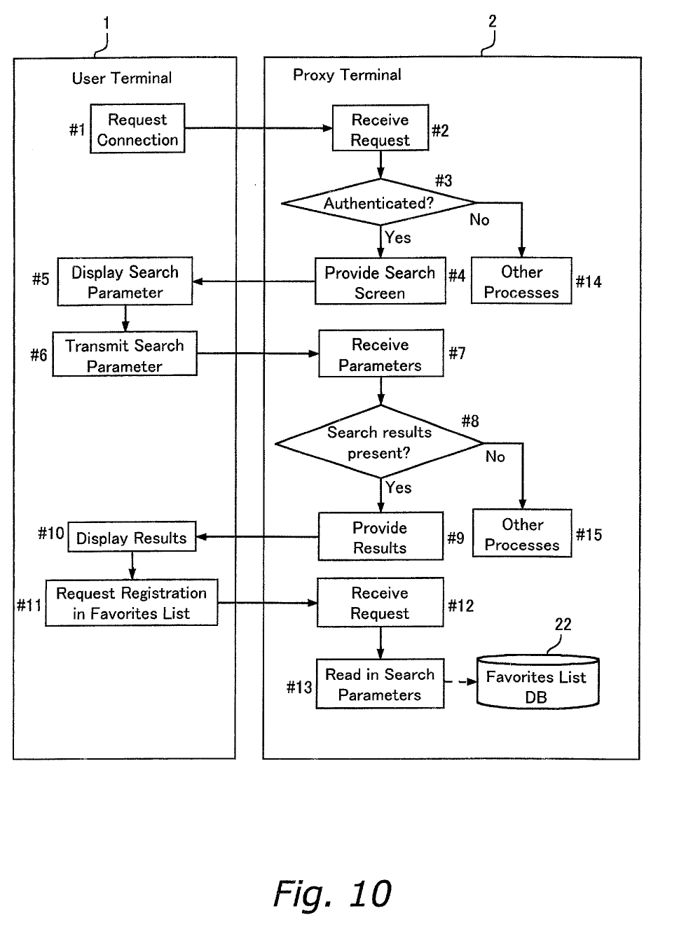

FIG. 10 is an explanatory diagram showing the flow of the search parameter save process.

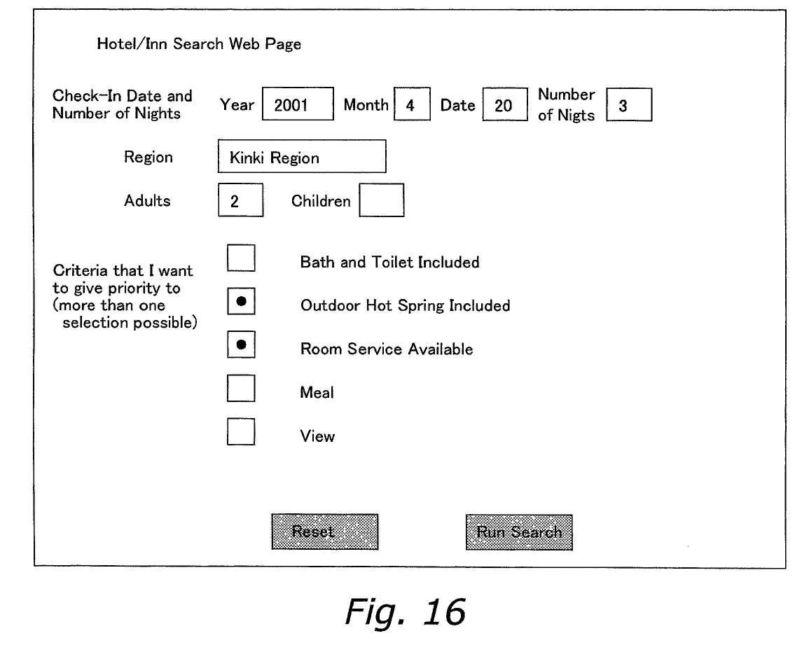

The user terminal 1 transmits a connection request that includes a user ID and a password to the proxy server 2 (#1) by means of the session request module 16. The proxy server 2 that receives this request refers to authentication DB 26 by means of an authentication module 212, and determines whether or not to authenticate the connection request (#2, #3). In the event that it is authenticated, the proxy server 2 provides a search screen for searching products by means of the product search module 27. A form for setting product search parameters is included in this search screen (refer to FIG. 16 discussed below).

The user terminal 1 receives the search parameter settings from the user via the search screen by means of the search parameter designation module 11, and transmits the aforementioned search parameters to the proxy server 2 by means of the product search request module 12 (#5, #6). The proxy server 2 receives the search parameters, refers to product DB 21 by means of the product search module 27, and determines whether or not there are hotels that match the search parameters (#7, #8). In the event that there are hotels that match, the product search module 27 presents a screen that displays the search results to the user terminal 1 (#9).

The user terminal 1 displays the search results by means of the favorites list registration module 13 (#10), and registers those hotels in its favorites list. For example, when the user drags and drops the selected hotels into the favorites list, a registration request that registers the selected hotels in the favorites list is transmitted from the user terminal 1 to the proxy server 2 (#11). The proxy server 2 receives this registration request by means of the favorites list management module 29, and registers the hotels selected and the aforementioned search parameters in favorites list DB 22 (#13).

In the event that the aforementioned connection request was not authenticated, the authentication module 212 of the proxy server 2 executes a process, for example, transmission of an error message such as “Password incorrect” to the user terminal 1 (#14). Further, in the event that there are no hotels that match the search parameters, the product search module 27 of the proxy server 2, for example, transmits the message “No hotels match the search parameters” (#15).

(3) Search Parameter Display Process and Search Parameter Change Process

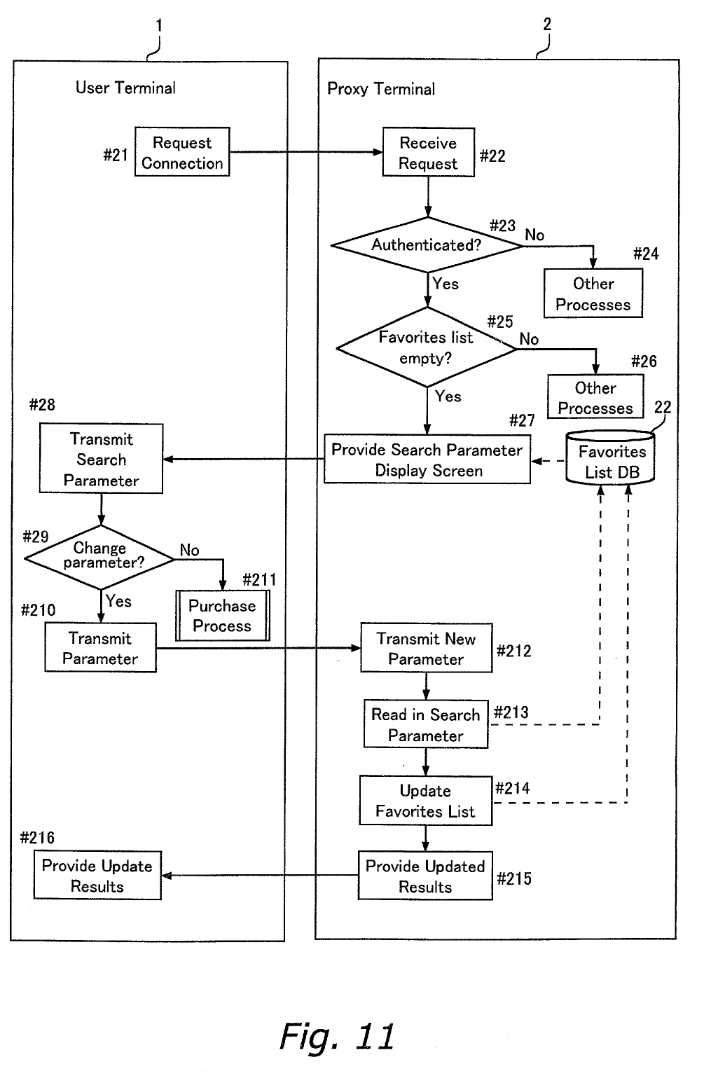

FIG. 11 describes an explanatory diagram of the search parameter display process and search parameter change process.

The user terminal 1 transmits a connection request that includes a user ID and password to the proxy server 2 by means of the session request module 16 (#21). The proxy server 2 receives this request, refers to authentication DB 26 by means of the authentication module 212, and determines whether or not to authenticate the connection request (#22, #23). In the event that the request is not authenticated, the error message described above, for example, will be transmitted to the user terminal 1 (#24). In the event that the request is authenticated, the proxy server 2 will determine whether or not products are registered in the favorites list of the user terminal 1 making the request by means of the favorites list management module 29 (#25). In the event that the favorites list is empty, the proxy server 2 will execute a process by means of the favorites list management module 29 that provide a screen to the user terminal 1 that indicates that there are no products displayed (#26). In the event that the favorites list is not empty, the favorites list management module 29 will provide the user terminal 1 with a screen that displays the hotels that are registered in the favorites list and the search parameters for these hotels (#27).

The user terminal 1 displays the aforementioned screen by means of the favorites list reference module 14 (#28). Further, the user terminal 1 can accept changes to the search parameters, hotel reservations, and the like on this screen (#28). In the event that the search parameters are changed, the favorites list change module 17 transmits the new search parameters to the proxy server 2 (#29, #210). In the event that a hotel reservation was made, a purchase process discussed below is executed (#211).

The proxy server 2 receives the new search parameters from the user terminal 1 by means of the favorites list management module 29, and stores them in favorites list DB 22 (#212, #213). In addition, the favorites list management module 29 updates favorites list DB 22 with the new search parameters (#214). For example, the favorites list management module 29 may delete the hotels that do not match with the new search parameters from the favorites list table. Further, the favorites list management module 29 may sort the hotels in the favorites list according to the degree to which they match the new search parameters. The favorites list management module 29 transmits an updated favorites list display screen to the user terminal 1 (#215). An updated favorites list is displayed in the user terminal 1 (#216).

(4) Product Information Presentation Process

The product information presentation process is generally classified into a user list reference process and a product information setting process. Both processes will be described below.

(4-1) User List Reference Process

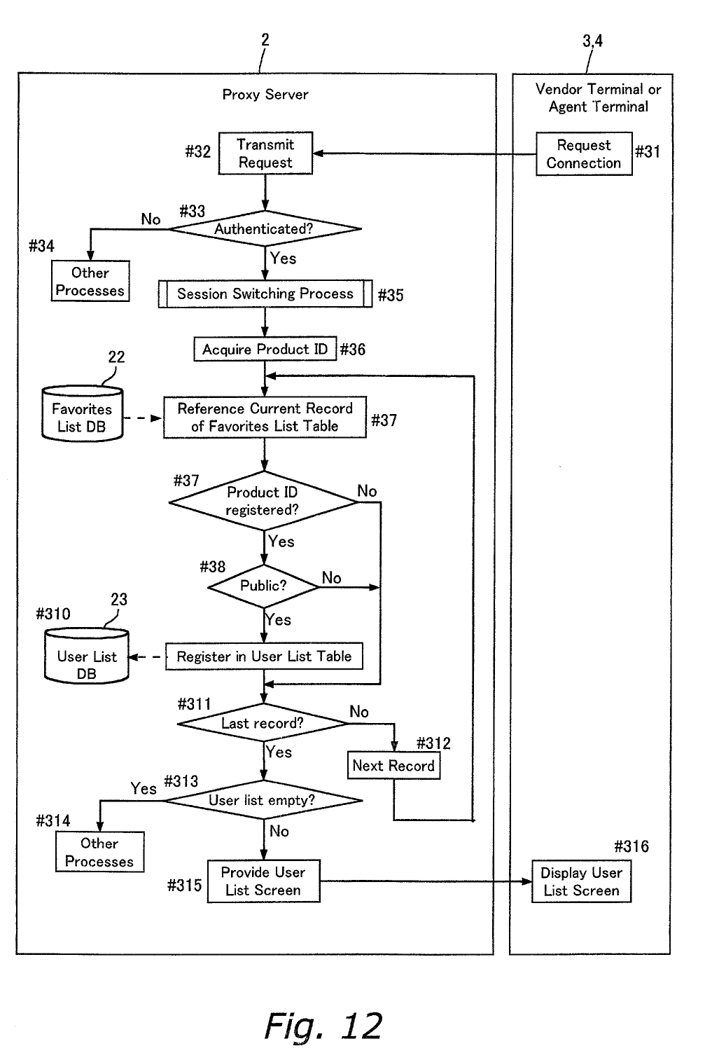

FIG. 12 describes an explanatory diagram showing the flow of the user list reference process. This process is executed between the proxy server 2 and the vendor terminal 3 or the agent terminal 4. Because the process flow is the same in either vendor terminal 3 or agent terminal 4, the process between the vendor terminal 3 and the proxy server 2 will be described below.

The vendor terminal 3 transmits a connection request that includes a vendor ID and a password to the proxy server 2 by means of the session request module 34 (#31). The proxy server 2 receives this request, refers to authentication DB 26 by means of the authentication module 212, and determines whether or not to authenticate the connection request (#32, #33). In the event that the request is not authenticated the authentication module 212 transmits the same message as described above to the vendor terminal 3 (#34). In the event that the request is authenticated, the proxy server 2 will execute a session switching process by means of the session switching module 213 (#35). In the process, the proxy server 2 will either establish a session with either vendor terminal 3 or agent terminal 4, or reject the establishment of a session and end the process. When a session is established with the vendor terminal 3, the following process will be executed.

The user list management module 211 of the proxy server 2 identifies the products that the vendor that established the connection provides (#36). In this embodiment, the vendor ID also serves as the product ID. The proxy server 2 refers to favorites list DB 22 by means of the favorites list management module 29, and reads out the current record of the favorites list table (#37). The default setting for the current record is the original record. The user list management module 211 determines whether or not the vendor ID, that is, the product ID, is registered in the current record (#38). In other words, the user list management module 211 determines whether or not products of the vendor that made a request are registered in the current record. In the event that the vendor ID is registered, the user list management module 211 determines whether or not public access to the record is allowed based upon the public flag (#39).

In the event that public access to the record is allowed, the user list management module 211 updates the user list table of user list DB 23 based upon the contents of the current record (#310). In other words, the user ID of the current record is added to the user list of the vendor that made the request. Specifically, the user list management module 211 extracts the user ID, date and time of registration, date and time of update, and display information from the current record of the favorites list, and adds them to the user list. In addition, the user list management module 211 searches the vendor IDs and the aforementioned user IDS in purchase history DB 24 by key, and requests the number of times of use and the reservation numbers.

The user list management module 211 determines whether or not the current record is the last record of the favorites list (#311). In the event that the current record is the last record, all users that have registered the aforementioned vendor in a favorites list are added to that vendor's user list. Intheevent that the current record is not the last record, the next record will be the current record, and processes #37 to #311 will repeat (#312). In the event that the current record is the last record, the proxy server 2 determines whether or not the user list of that vendor is empty (#313). If the user list is empty, the user list management module 211 will transmit, for example, the message “That user is not present” to the vendor terminal 3 (#314). If the user list is not empty, a user list display screen that displays the user list will be transmitted to the vendor terminal 3 (#315). In this way, a group of users that have registered a vendor's products in a favorites list will be displayed in the vendor terminal 3 (#316).

(4-2) Product Information Setting Process

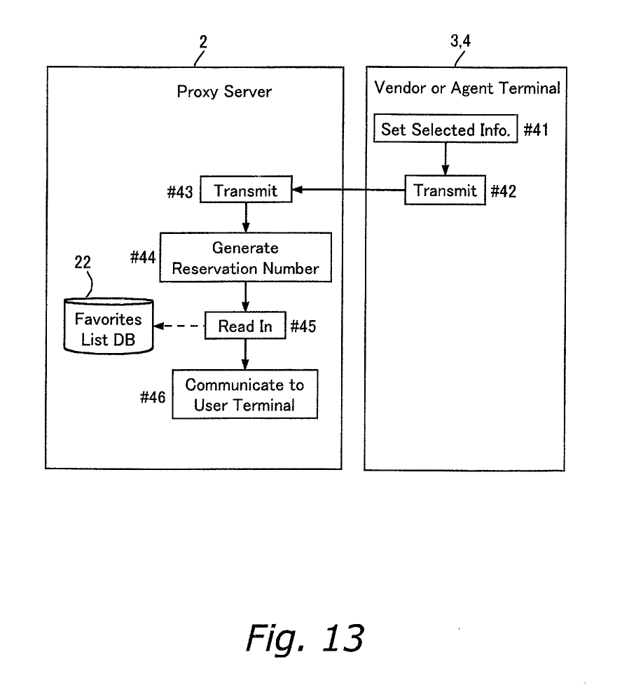

FIG. 13 shows an explanatory diagram showing the flow of the product information setting process. The user list display screen that is displayed in vendor terminal 3 by means of the aforementioned user list reference process accepts user selection settings and display information settings (#41). When a button on this screen is pushed that indicates, for example, the providing of presented information, presented information is transmitted to the proxy server 2 (#42). At this time, both the user ID selected and the vendor ID are transmitted together with the display information.

When the proxy server 2 receives the display information by means of the user list management module 211, a reservation number is generated by means of favorites list management module 29 (#43, #44). The presented information and the reservation number as payment ID are written in a favorites list table record that is specified by user ID, and vendor ID (#45). In addition, the proxy server 2 communicates the information provided from the vendor to the user terminal 1 (#46). For example, an indicator can be turned on/off on the favorites list display screen to show the presence or absence of information provided from the vendor.

(4-3) Session Switching Process

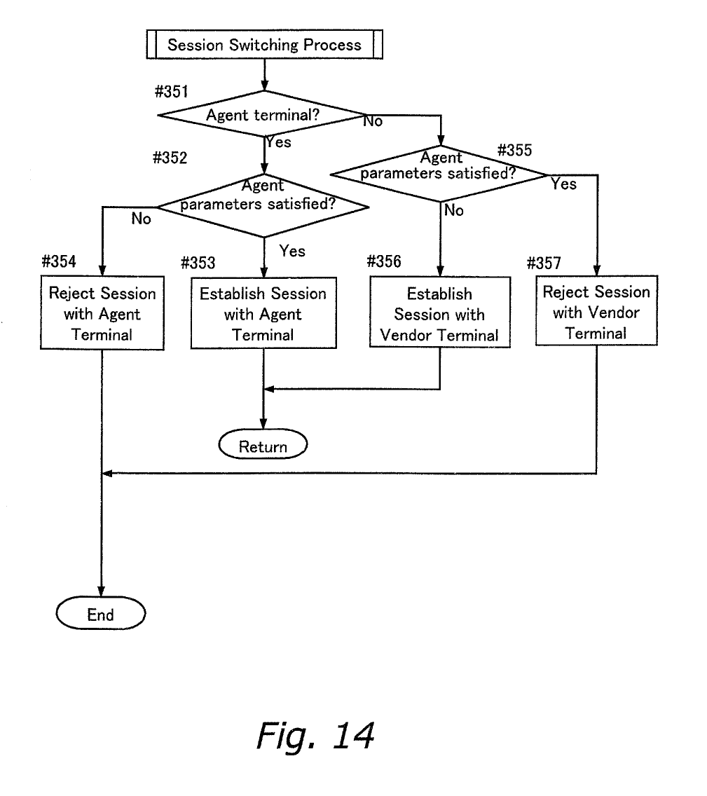

FIG. 14 shows an explanatory diagram of the flow of the session switching process. In this process, a session between the vendor terminal 3 or the agent terminal 4 is established according to the agent parameters of agent DB 26. In the aforementioned user list reference process, when the vendor terminal 3 or the agent terminal 4 was authenticated, the following session switching process was initiated (#35 of FIG. 12).

First, a session switching module 213 of the proxy server 2 determines whether or not the terminal that was authenticated is an agent terminal (#351). If the terminal that was authenticated is an agent terminal, the session switching module 213 searches the agent parameters in agent DB 26 by agent ID of the agent terminal as a key, and determines whether or not the agent parameters have been satisfied (#352). Using the agent DB shown in FIG. 8 as an example, if the agent ID of an agent terminal is “CS-002”, the answer is determined to be “Yes” when the time is between 23:00 and 8:00. Further, if the agent ID is “CS-059”, the answer is determined to be “Yes” when vendor terminal “vendor-D” is off line. If the answer is determined to be “Yes”, the session switching module 213 establishes a session with the agent terminal (#353). When the answer is determined to be “No”, the session switching module 213 rejects the establishment of a session with the agent terminal, and terminates the process (#354).

In the event that a vendor terminal is the terminal that is authenticated, the session switching module 213 searches the agent parameters by vendor ID as a key, and determines whether or not the agent parameters have been satisfied (#355). When the answer is determined to be “No”, in other words, under parameters in which the vendor terminal itself refers to the user list or sets the display information, the session switching module 213 establishes a session with a vendor terminal (#356). When the answer is determined to be “Yes”, in other words, under parameters in which the vendor terminal relies upon the agent terminal 4 for a process, the session switching module 213 will reject the establishment of a session with the vendor terminal, and will terminate the process (#357).

(5) Purchase Process

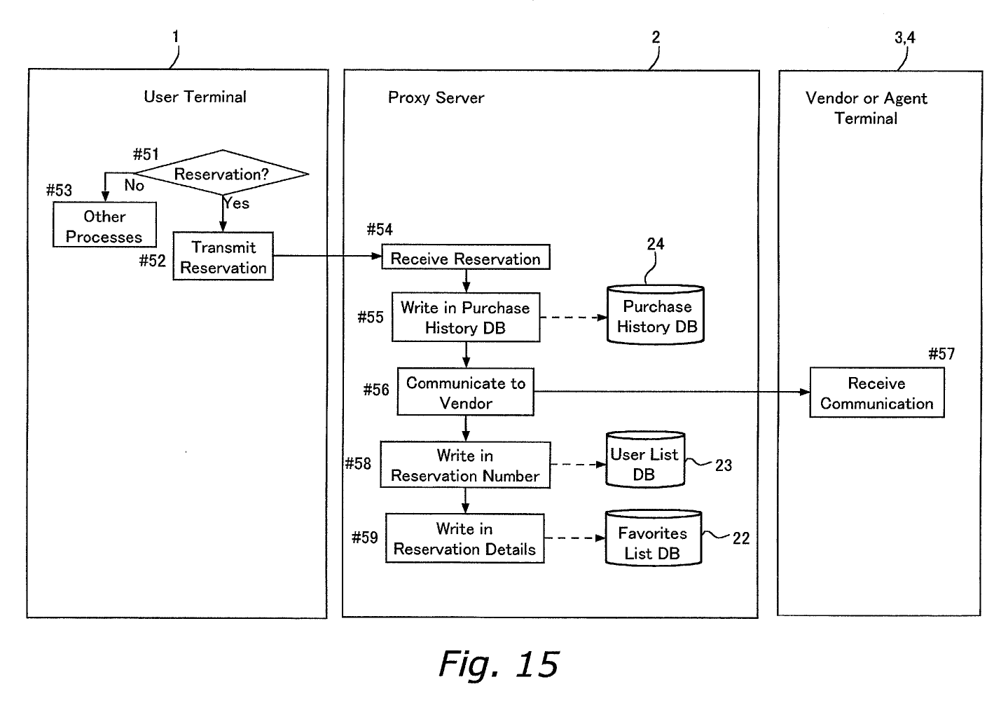

FIG. 15 shows an explanatory diagram showing the flow of the purchase process.

In the aforementioned search parameter display process and the search parameter change process, the favorites list display screen is provided in the user terminal 1 (#28 of FIG. 11). A user can select a product, in other words, a hotel, and make a reservation with this screen. In the event that any hotel reservation is requested (#51), the favorites list change module 15 of the user terminal 1 transmits a reservation request that includes a vendor ID combined with a user ID and a product ID (#52). In the event that this screen accepts other processes, the other processes are executed (#53). A process that sorts favorite products in an order specified by the user can be one of these other processes.

The proxy server 2 receives the reservation request by means of the favorites list management module 29, and generates a reservation number (#54). Further, favorites list management module 29 generates reservation details based upon parameter data that corresponds to the user terminal that requested the reservation. Moreover, the favorites list management module 29 writs the reservation number, vendor ID, reservation details, and user ID into purchase history DB 24 (#55). The user list management module 211 may communicate the reservation to the vendor terminal 3 (#56, #57). This communication can, for example, be via e-mail or the like.

The proxy server 2 accesses user list DB 23 by means of user list management module 211, and writs the reservation number in a record in the user list table that is specified by the ID of the user terminal that requested the reservation and the aforementioned vendor ID (#58). In this way, when the vendor terminal 3 refers to the user list, it can be determined whether or not a user has purchased that company's product.

In addition, the proxy server 2 accesses favorites list DB 22 by means of the favorites list management module 29, and writs the reservation details into a record of the favorites list table that is specified by the aforementioned user ID and the aforementioned vendor ID (#59). For example, “2001/6/2-4, two adults, outdoor hot spring available” can be written in as reservation details.

### Screen Example

Next, examples of the screens displayed in the user terminal 1 and the vendor terminal 3 of the sales increasing system of the present embodiment will be described.

FIG. 16 shows an example of a search parameter selection screen. This screen accepts search parameter items and the details thereof. When a user pushes the “Run search” button, the designated search parameters are transmitted to the proxy server 2.

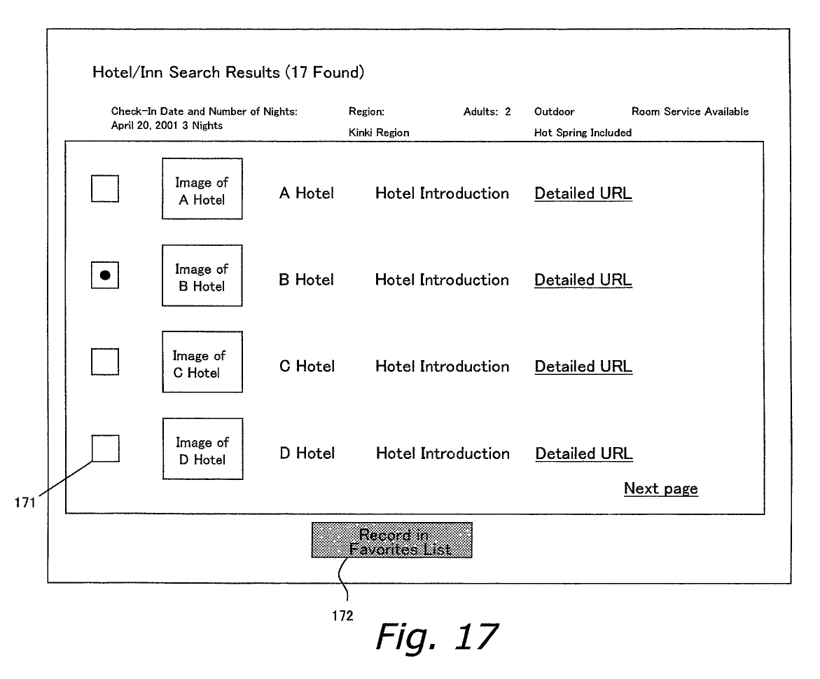

FIG. 17 shows an example of a favorites list registration screen. This screen displays the products that match the search parameters designated in FIG. 16. A user selects products by checking check box 171, and when the “Register in favorites list” button is pushed, the selected products are registered in favorites list DB 22 as favorite products.

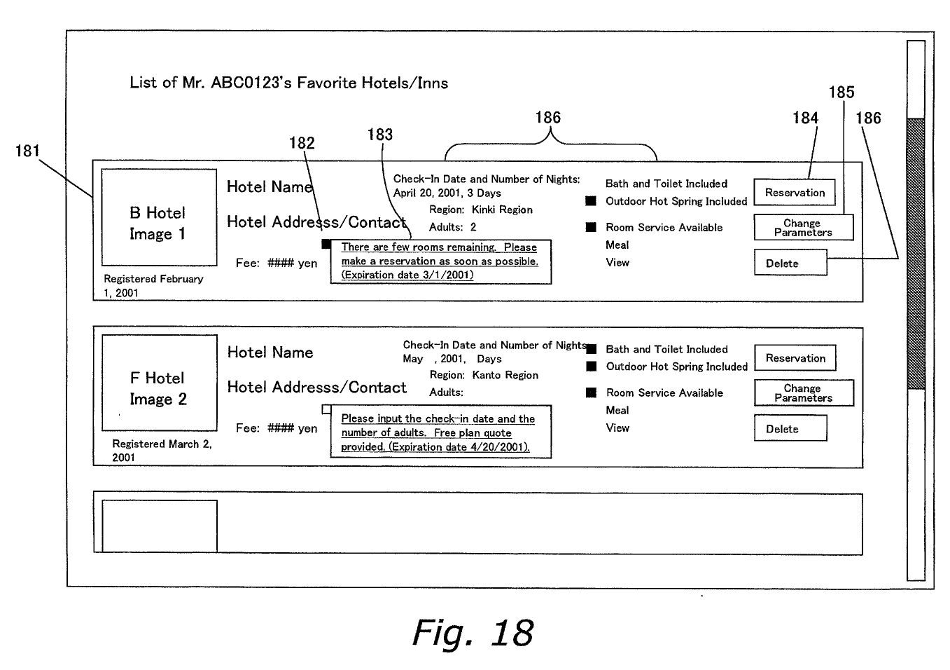

FIG. 18 shows an example of a favorites list display screen that includes search parameters. Icons 181 for the products registered in the favorites list of FIG. 17, and their search parameters 186, are displayed in this screen. This is convenient because a user can confirm the characteristics of each product by referring to the search parameters of each product. Further, product icons 181 are displayed together with the-month, day, and year of registration in the favorites list. If an indicator 182 is illuminated, this indicates that display information from the hotel as the product provider has arrived. Display information 183 is displayed by clicking on the indicator 182.

When a user pushes “Reservation button” 184, a reservation is made at the hotel that corresponds to that button. Further, when a user pushes “parameters change” button 185, the search parameter designation screen illustrated in FIG. 16 is, for example, displayed and the user can change the search parameters. When “Delete” button 186 is pushed, the corresponding products are deleted from the favorites list.

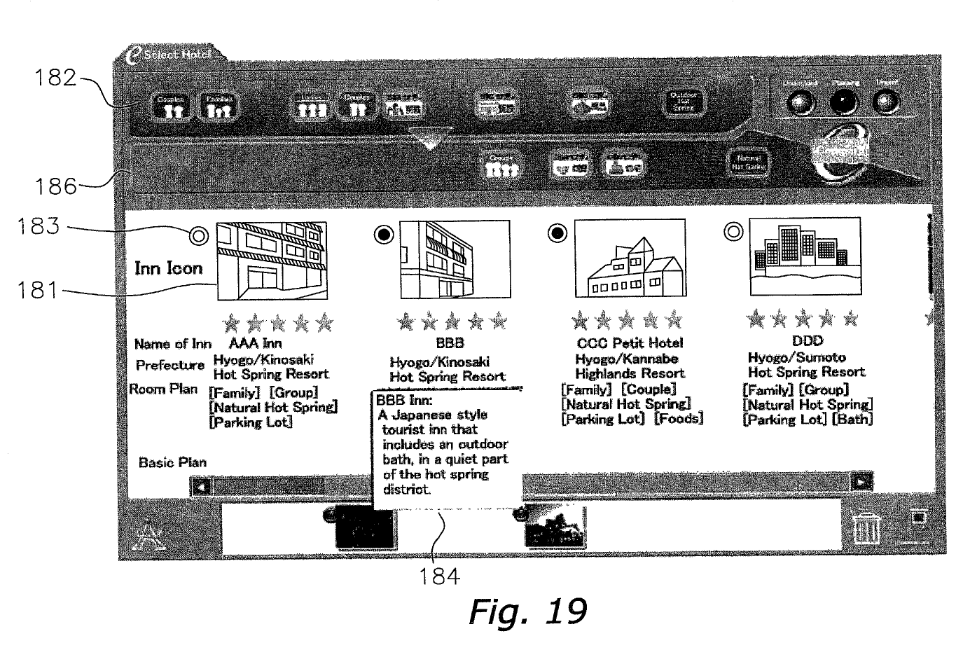

FIG. 19 shows another example of a favorites list display screen that includes search parameters. In this screen, products 181 registered in a favorites list and the search parameters 186 are displayed in icon form. Icons that show the search parameter items that can be set are displayed in item field 182. A user drags these icons to the search parameters 186, and can change the search parameters by performing the reverse operation. Like in FIG. 18, if indicator 183 is clicked, display information 184 will be displayed.

(2) Examples of the Screens Displayed by the Vendor Terminal 3 and the Agent Terminal 4

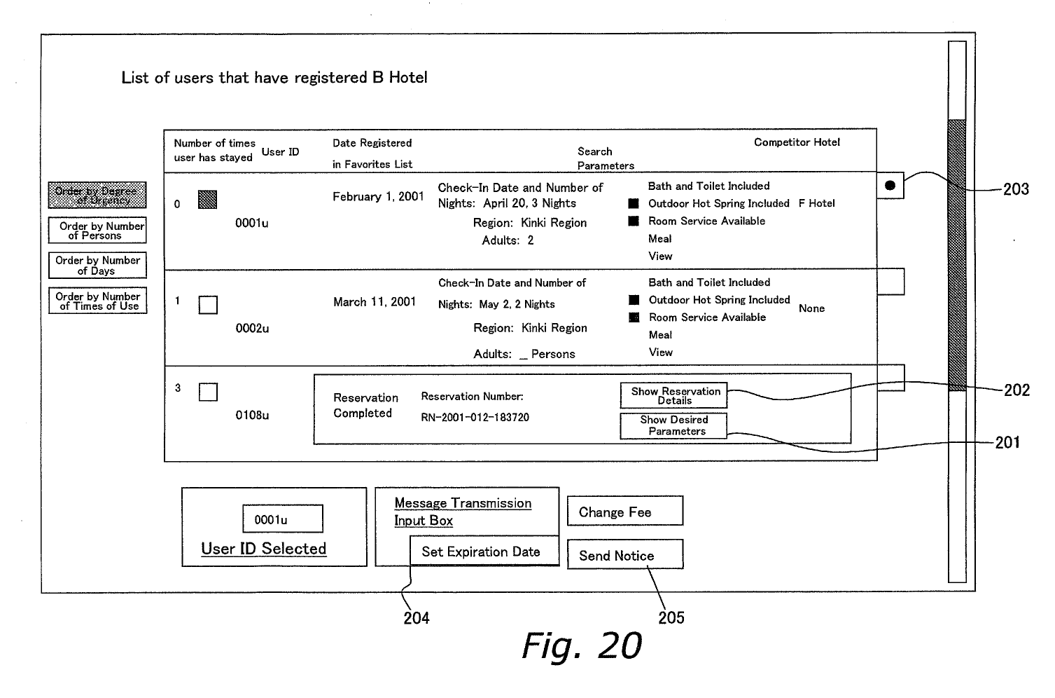

FIG. 20 shows an example of a user list display screen. This screen shows the user list of B Hotel as a vendor. The screen displays the user ID, the number of times the user has stayed in B hotel, the month, day and year that it was registered in the favorites list, the search parameters that retrieved B hotel, and other hotels that are registered in the user's favorites list. Users “0001U” and “0002U” have not yet made a reservation at B Hotel. The vendor can click “Select user button” 203 and select a user without a reservation, can write display information into “Input message to be transmitted” box 204, and by pushing “Send notice button” 205, can register the presented information in the favorites list.

On the other hand, reservation number “RN-2001-012-183720” is displayed in the user “0108U” entry, and indicates a user that has made a reservation. A vendor can see the user's search parameters by pushing “Show desired parameters button” 201. In addition, a vendor can see the reservation details by pushing “Show reservation details button” 202.

Other Embodiments

(A) In the aforementioned sales increasing system, an example was described in which the vendor terminals 3 were hotel computers, and the agent terminals 4 were host terminals in a travel agency. However, other examples can be considered. For example, the vendor terminals 3 may be computer terminals placed in each regional branch office of a travel agency, and the travel agency host terminals may serve as both the proxy server 2 and the agent terminals 4.

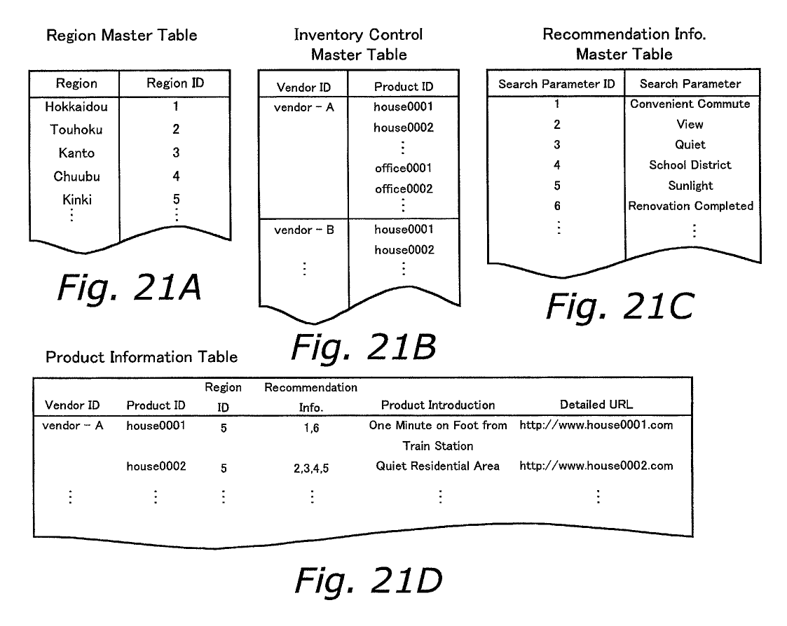

(B) Moreover, in the aforementioned sales increasing system, a vendor provides only one product, and the vendor ID is combined with the product ID. However, a vendor can provide a plurality of products, and the vendor ID and product IDs can be different. For example, a situation can be cited in which the vendor is a real estate agency that handles a plurality of properties. FIG. 21 describes an explanatory diagram showing a product information DB 21 in this situation.

The regional master table is similar to that of FIG. 3. The search parameter items that are used in real estate as product sales and rentals are matched with the search parameter IDs and stored in the recommendation information master table. The vendor ID is matched with the IDs of the products that the vendor provides in the inventory control table. The region, recommendation information, product introduction, and detailed URL are stored in the product information table as detailed information on each product ID. In this situation, products can be uniquely identified by the combination of vendor ID and product ID.

Both the vendor ID for identifying the product and the product IDS can be indicated in the favorites list table of favorites list DB 22 (not shown in the figures). Further, both the vendor ID for specifying the product and the product ID are indicated in the user list table of user list DB23 (not shown in the figures).

(C) The present invention includes a program that runs the processes of the aforementioned sales increasing system, and a computer-readable recording medium in which that program is stored. A computer readable floppy disk, hard disk, semiconductor memory, CD-ROM, DVD, magneto-optical disk (MO), and other similar items can be mentioned as recording media.

If the present invention is employed, users can save the search parameters used to search for products on a network, and thus the search parameters can be available for use at a later date.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. An information presentation method that is employed in an information presentation system, in which a user retrieves a product or service on a network that matches designated search parameters designated by the user, and presents it to said user, said information presentation method comprising the steps of:
storing said search parameters and said product or service;
reporting the product or service and the search parameters that were stored to a provider of said product or said service;
accepting settings of information relating to said product or service from said product/service provider; and
presenting information to said user that relates to the product or service that was set.

2. An information presentation device in which a user terminal on a network that retrieves products or services that match search parameters designated by the user, said information presentation device comprises:
accepting means for accepting a selection of a product or service that is included in said products or services that were retrieved; and
parameter storage means for storing the search parameters for the selected product or service as a candidate for purchase, together with user identification information that identifies said user terminal.

3. The information presentation device according to claim 2, further comprising:
user reference request accepting means for accepting user reference requests from first group of computer terminals on said network; and
parameter providing means for extracting from said parameter storage means a first user identification information identifying said first user terminals that have selected a first product as a candidate for purchase that is provided by an administrator of a provider terminal included in said first computer terminals, and search parameters that each of said first user terminals has set to said first product, and providing them to said provider terminal.

4. The information presentation device according to claim 3, further comprising:
information setting means for receiving from said provider terminal the designation of user identification information included in said first user identification information provided to said provider terminal, and product information settings for said designated user identification information;
product information storage means for storing said designated user identification information, said first product, and the product information that was set; and
information presentation means for receiving a purchase candidate reference request from a designated user terminal identified by said designated user identification information, extracting from said parameter storage means candidates for purchase that correspond to said designated user identification information, extracting said product information set for said first product that is included in said candidates for purchase from said product information storage means, and providing the extracted candidates for purchase and said product information to said designated user terminal.

5. The information presentation device according to claim 2, further comprising first parameter providing means for receiving a purchase candidate reference request from said user terminal, extracting candidates for purchase that correspond to the user identification information for the user terminal that made the request, and providing the extracted candidates for purchase and the search parameters to said user terminal that made the request.

6. The information presentation device according to claim 5, further comprising:
change means for receiving changes to the search parameters provided to said user terminal that made the request;
candidate update means for updating the candidates for purchase that correspond to the user identification information of said user terminal that made the request, based upon the changed search parameters; and
second parameter providing means for providing updated candidates for purchase and new search parameters to said user terminal that made the request.

7. The information presentation device according to claim 5, further comprising:
purchase means for receiving designations of products or services included in the candidates for purchase from said user terminal and purchase designations;
purchase history storage means for storing the designated products or designated services received by said purchase means, and a user identification information identifying the user terminal that made the designations;
user reference request receiving means for receiving a user reference request from said first computer terminals on said network; and
purchase information presentation means for extracting from said parameter storage means a first user identification information identifying a first user terminals that have selected products or services as candidates for purchase that are provided by the administrator of a provider terminal included in said first computer terminals, and search parameters that each of said first user terminals has set to said products or services, generating a purchase information that indicates whether or not each of said first user terminals has completed a purchase of said products or said services based on the purchase history storage means, and providing the extracted first user identification information, the extracted search parameters, and the generated purchase information to said provider terminal.

8. The information presentation device according to claim 7, wherein said purchase history storage means further stores said first identification information that identifies said first computer terminals and said designated products correlatively; and
said information presentation device further comprises history dissemination means for providing the purchase history of the products that said administrator of said provider terminal provides.

9. The information presentation device according to claim 3, further comprising an agent terminal storage means for correlatively storing third identification information for representing second computer terminals that is included in said first computer terminals, and for identifying third computer terminals that are included in said first computer terminals, and a second identification information that identifies second computer terminals that are represented by each of said third computer terminals identified by said third identification information.

10. The information presentation device according to claim 3, further comprising an agent terminal storage means for correlatively storing third identification information for representing second computer terminals that is included in said first computer terminals, and for identifying third computer terminals that are included in said first computer terminals, and second identification information that identifies second computer terminals that are represented by each of the third computer terminals identified by said third identification information;
agent parameter storage means for storing agent parameters for agent terminals that are included in said third computer terminals to represent provider terminals that are included in said second computer terminals, together with said third identification information for said agent terminals and said second identification information for said provider terminals; and
an agent means for receiving a connection request from said second computer terminals or said third computer terminals, setting up said connection or rejecting said connection according to said agent parameters.

11. An information presentation method used in a computer, that retrieves products or services that match search parameters selected by user terminals on a network and presents them to said user terminals, said information presentation method comprising the steps of:
receiving a selection of any product or service that is included in the products or services retrieved; and
storing the search parameters that retrieved the products or services as candidates for purchase together with user identifying information that identifies said user terminal.

12. A computer program product for an information presentation and for being employed in a computer that retrieves products or services that match search parameters selected by user terminals on a network and presents them to said user terminals, comprising:
receiving means for receiving a selection of any product or service that is included in the products or services retrieved; and
parameter storing means for storing the search parameters that retrieved the products or services as candidates for purchase together with user identifying information that identifies said user terminals.

13. A computer readable recording medium, on which an information presentation program is recorded and employed in a computer that retrieves products or services that match search parameters selected by user terminals on a network and presents them to said user terminals, said information presentation program recorded on a computer readable recording medium comprising the steps of:
receiving a selection of any product or service that is included in the products or services retrieved; and
storing the search parameters that retrieved the products or services as candidates for purchase together with user identifying information that identifies said user terminals.

14. A computer terminal that receives search parameter selections for searching products or services on a network, and reports the products or services that match said search parameters to users, said computer terminal on a network comprising:
candidate selection means for selecting any product or service that are included in said product group or said service group as candidates for purchase;
transmission means for transmitting said candidates for purchase and the search parameters therefor to an information presentation device on said network that stores purchase candidates and search parameters for each of said purchase candidates;
request means for transmitting a reference request for referencing the purchase candidates to said information presentation device;
acquiring means for acquiring the purchase candidates and the search parameters for each of said purchase candidate from said information presentation device; and
output means for outputting purchase candidates acquired and search parameters acquired for each of said purchase candidates.

15. A computer terminal on a network that is operated by a product provider or a service provider, said computer terminal comprising:
user reference request means for retrieving products or services that match search parameters designated by user terminals on said network and presenting them to said user terminals, receiving any product or service selection that is included in the products or services retrieved, and transmitting a user reference request via said network to an information presentation device that stores the search parameters of the products or services retrieved as purchase candidates, and user identification information that identifies said user terminals;
parameter acquiring means for acquiring a first user identifications corresponding to a first user terminals that select products or services provided by said product provider or said service provider as purchase candidates, and search parameters that is set to each of said products or services of said first user terminals; and
an output means for outputting said first user identifications acquired and said search parameters acquired.
